(19) United States
(12) Patent Application Publication
(10) Pub. No.: US 2023/0357287 A1
(43) Pub. Date: Nov. 9, 2023

(54) N,O-TYPE MULTIDENTATE FUNCTIONAL MONOMER, PREPARATION METHOD THEREOF AND APPLICATION THEREOF IN ION-IMPRINTED POLYMERS

(71) Applicant: WUHAN SEPENRICH TECHNOLOGIES CO., LTD, Wuhan (CN)

(72) Inventors: Jun XING, Wuhan (CN); Liangqun CHEN, Wuhan (CN)

(21) Appl. No.: 18/353,848

(22) Filed: Jul. 17, 2023

Related U.S. Application Data
(63) Continuation of application No. PCT/CN2020/140732, filed on Dec. 29, 2020.

(30) Foreign Application Priority Data
Jan. 17, 2020 (CN) 202010055553.2

(51) Int. Cl. B01J 20/26; C07F 7/18

(52) U.S. Cl. CPC C07F 7/1892; B01J 20/268

(57) ABSTRACT

The present invention disclose a N,O-type multidentate functional monomer(AAPTS-COOH), a preparation method thereof and an application thereof in ion-imprinted polymers, and belongs to the technical field of separation materials. The N,O-type multidentate functional monomer of the present invention is obtained through the Michael addition reaction of N-aminoethyl-γ-aminopropyltrimethoxysilane and acrylic esters, bonding an ester group to the amino group and imine group of N-aminoethyl-γ-aminopropyltrimethoxysilane, and hydrolyzing the ester group with a trifluoroacetic acid solution. The 2 nitrogen atoms and 3 oxygen atoms in the functional monomer can coordinate with metal ions. The N,O-type multidentate functional monomer prepared by the present invention can be used to prepare an ion-imprinted polymer (IIP). The imprinted material has high selective adsorption capacity for copper ions and nickel ions. In addition, the IIP synthesis method based on AAPTS-COOH of the present invention has good universality.

### CROSS-REFERENCE TO RELATED APPLICATIONS

This application is a continuation of International Application No. PCT/CN2020/140732 with a filling date of Dec. 29, 2020, designating the United states, now pending, and further claims to the benefit of priority from Chinese Application No. 202010055553.2 with a filing date of Jan. 17, 2020. The content of the aforementioned applications, including any intervening amendments thereto, are incorporated herein by reference.

### FIELD OF THE INVENTION

The present invention belongs to the technical field of separation materials, and particularly relates to a N,O-type multidentate functional monomer, a preparation method thereof and an application thereof in ion-imprinted polymers.

### BACKGROUND OF THE INVENTION

As an essential trace element in all living organisms, copper is a component of several enzymes involved in electron flow and a major catalyst in redox reactions, and is irreplaceable in the life cycle. However, excessive copper may cause irreversible damage to the body. Increased copper concentration in the blood can cause symptoms such as hypotension, black stools, coma, jaundice, and gastrointestinal discomfort. Long-term exposure to copper can also damage the liver and kidneys. The maximum contaminantlevel of copper in drinking water is 1.3 mg/L. If the content exceeds the standard, it will cause harmful effects on the human body and the ecological system. Wastewater containing heavy metal ions such as copper should be properly disposed of. At present, methods adopted industrially lack selectivity. To remove or isolate specific metal ions from a mixture, selective separation methods are required.

Molecular imprinting technology (MIP) is a technique to use a target molecule as a template and make functional monomer to form a specific spatial distribution around the template through the interaction between the functional monomer and the template, and add a cross-linking agent to form a template-containing polymer through a polymerization reaction. After template molecules are removed, cavities with the same shape as the template molecules and specific distribution of recognition sites are left in the polymer. The material with these specific cavities is a molecularly imprinted material. Theoretically, there should be a specific selectivity similar to “antigen-antibody” between molecularly imprinted materials and template molecules. Although the current imprinted materials are not able to offer the desired “specificity”, their separation selectivity is still far better than that of ordinary separation materials.

Ion-imprinted polymer (IIP) refers to the imprinted polymer prepared with metal ions as templates. Although IIP can be used to separate and enrich specific metal ions, relative to MIP, the selectivity of existing IIP is generally low. The reasons are as follows: firstly, the metal ions are very similar in size and charge, making it difficult to identify; secondly, most of the existing functional monomers are monodentate ligands, and the complexes of these monomers and metal ions are not stable and the imprinting effect is not good; furthermore, the functional monomers used in the synthesis of IIP are excessive, which necessarily causes non-specific adsorption; therefore, the imprinting materials based on the existing functional monomers cannot provide a highly specific ion recognition microenvironment.

### SUMMARY OF THE INVENTION

In view of the problems existing in the prior art, the object of the present invention is to provide a N,O-type multidentate functional monomer, a preparation method thereof and an application thereof in ion-imprinted polymers. In the present invention, a N,O-type multidentate functional monomer is synthesized, and on this basis, an ion-imprinted polymer with better selectivity to metal ions is synthesized. The imprinted materials obtained in the present invention have high selectivity for metal ions, for example, Cu²⁺, Ni²⁺, etc.

In order to achieve a first object, the present invention adopts the followingtechnical solutions:

A method for preparing a N,O-type multidentate functional monomer(AAPTS-COOH), specifically comprising the following steps:
(a) adding an organic solvent, N-aminoethyl-γ-aminopropyltrimethoxysilane, and acrylic esters to a three-necked flask equipped with a nitrogen tube and a stirring device sequentially, stirring well, introducing N₂into the reaction system for deoxygenation, heating the reaction system to a certain temperature between 40-60° C. and reacting for 6-28 hours at a constant temperature; after completion of reaction, carrying out rotary evaporation to remove the organic solvent to obtain a Michael addition product; wherein: the molar ratio of theN-aminoethyl-γ-aminopropyltrimethoxysilane to the acrylic esters is 1:3-1:60;
(b) adding a trifluoroacetic acid aqueous solution to the Michael addition product obtained in the step (a), and hydrolyzing at room temperature for 0.5-3 hours; after completion of the hydrolysis reaction, subjecting the hydrolysis product to rotary evaporation, precipitation, filtration, and purification by washing several times to obtain the N,O-type multidentate functional monomer, which is sealed and refrigerated for future use.

The N,O-type multidentate functional monomer AAPTS-COOH is a siloxane monomer with three carboxylic acid groups and two N atoms, the structural formula being as follows:

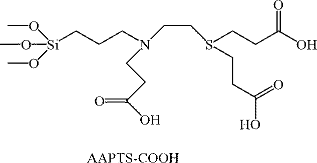

The N,O-type multidentate functional monomer can form six-membered rings and five-membered rings simultaneously with metal ions.

Further, in the above technical solution,the acrylic esters in the step (a) can be any one of methyl acrylate, ethyl acrylate, propyl acrylate, butyl acrylate, isobutyl acrylate, tert-butyl acrylate, pentyl acrylate, and hexyl acrylate. More preferably, the acrylic esters are tert-butyl acrylate.

Further, in the above technical solution, the organic solvent in the step (a) is any one of methanol or ethanol.

Further, in the above technical solution, the molar ratio of the N-aminoethyl-γ-aminopropyltrimethoxysilane to the acrylic esters in the step (a) is preferably 1:5.

Further, in the above technical solution, the reaction temperature in the step (a) is preferably 50° C., and the reaction time is preferably 24 h.

Further, in the above technical solution, the mass fraction of the trifluoroacetic acid aqueous solution in the step (b) is 1-98%, preferably 95%.

Further, in the above technical solution, the hydrolysis time in the step (b) is preferably 1 h.

A second object of the present invention is to provide a N,O-type multidentate functional monomer(AAPTS-COOH) prepared by the method for preparing N,O-type multidentate functional monomer(AAPTS-COOH).

A third object of the present invention is to provide an application of the N,O-type multidentate functional monomer(AAPTS-COOH) prepared by the above method in ion-imprinted polymers (IIP).

A method for synthesizing an ion-imprinted polymer (IIP) is provided, comprising the following steps:
(1) dissolving aN,O-type multidentate functional monomer in an organic solvent to obtain a functional monomer solution; dissolving template metal ions in a buffer solution to obtain a metal ion solution; then mixing the functional monomer solution with the metal ion solution well to obtain a metal ion-functional monomer prepolymerization complex solution; wherein: the molar ratio of the N,O-type multidentate functional monomer to the template metal ions is 1:1;
(2) adding a cross-linking agent tetraalkoxysilane to the prepolymerization complex solution obtained in the step (1), stirring until the solution is clear, then adding ammonia water solution, mixing well and heating to 40-100° C., reacting under a stirring condition for 18-30 hours to obtain a bulk polymerization product, wherein the molar ratio of the cross-linking agent tetraalkoxysilane to the multidentate functional monomer is (3-50):1;
(3) aging the bulk polymerization product obtained in the step (2) at 60-90° C. for 3-48 hours, then taking out, cooling, grinding and sieving, removing the template metal ions with hydrochloric acid, and then washing with water until neutral, finally performing vacuum drying to obtain the ion-imprinted polymer.

Furthermore, in the above technical solution, the organic solvent described in the step (1) is methanol or ethanol.

Furthermore, in the above technical solution, the volume ratio of the organic solvent to the buffer solution in the step (1) is 1:1-10.

Furthermore, in the above technical solution, the buffer solution in the step (1) is preferably deionized water with a pH value of 3-9.

Further, in the above technical solution, the metal ion in the step (1) is any one of Cu²⁺ and Ni²⁺.

Further, in the above technical solution, the tetraalkoxysilane in the step (2) is preferably tetraethoxysilane (TEOS), and the molar ratio of the tetraethoxysilane to the N,O-type multidentate functional monomer is preferably 10:1.

Further, in the above technical solution, the dosage ratio of the ammonia waterto the cross-linking agent tetraalkoxysilane in the step (2) is (0.1-20) mL: 0.06 mol.

Furthermore, in the above technical solution, the concentration of the ammonia water solution in the step (2) is 2-28%.

Furthermore, in the above technical solution, the reaction temperature in the step (2) is preferably 90° C., and the reaction time is preferably 24 h.

Furthermore, in the above technical solution, the aging temperature in the step (3) is preferably 80° C., and the aging time is preferably 24 h.

Furthermore, in the above technical solution, the size of the solid product obtained by grinding and sieving in the step (3) is preferably 200-300 mesh.

A fourth object of the present invention is to provide an ion-imprinted polymer obtained by the above method for synthesizing the ion-imprinted polymer (IIP).

Further, in the above technical solution, the ion-imprinted polymer is preferably any one of a copper ion-imprinted polymer (Cu²⁺-IIP) or a nickel ion-imprinted polymer (Ni²⁺-IIP).

The application of the ion-imprinted polymer in the selective adsorption of metal ions described above in the present invention has high selective adsorption capacity for metal ions (for example, Cu²⁺, Ni²⁺, etc.) in water.

The usage method of theion-imprinted polymer described above in the present invention is specifically as follows:

the solution to be tested (metal ion solution) is adjusted to pH of 2-12, then the ion-imprinted polymer is added.

### BRIEF DESCRIPTION OF THE DRAWINGS

FIG. 1 is a synthesis route of N,O-type multidentate functional monomer (AAPTS-COOH) of Example 1 of the present invention.

FIG. 2 is infrared spectra (FT-IR) of Example 1, wherein A represents N-aminoethyl-γ-aminopropyltrimethoxysilaneAAPTS, B represents Michael addition product AAPTS-tBu, and C represents N,O-type multidentate functional monomerAAPTS-COOH.

FIG. 3 is a scanning electron microscope (SEM) image (A) and an infrared (FT-IR)spectrum(B) of the ion-imprinted polymer Cu²⁺-IIP prepared in the Application Example 1 of the present invention.

FIG. 4 is a Zeta potential test result chart of ion-imprinted polymer Cu²⁺-IIP prepared in the Application Example 1 of the present invention under different pH environments.

### DETAILED DESCRIPTION

The present invention will be further described in detail below in conjunction with embodiments. These embodiments will be implemented on the premise of the technology of the present invention. Presently, detailed embodiments and specific operation process are given to illustrate the inventiveness of the present invention, but the protection scope of the present invention is not limited to the following embodiments.

According to the information contained herein, various changes in the precise description of the present invention will readily become apparent to those skilled in the art without departing from the spirit and scope defined in the appended claims. It should be understood that the scope of the present invention is not limited to the processes, properties or components defined, since these embodiments and other descriptions are only intended to illustrate certain aspects of the present invention. In fact, it is apparent for those skilled in the art or related arts to make changes to the embodiments of the present invention that fall within the protection scope as defined by the appended claims.

In order to better understand but not to limit the protection scope of the present invention, all figures representing dosage, percentage, and other numerical values used in this application should be understood as being modified by the term “about” in all cases. Accordingly, unless expressly indicated otherwise, the numerical parameters set forth in the specification and appended claims are approximations that may vary depending upon the desired properties sought to be obtained. At a minimum, each numerical parameter should be construed to be available in light of the reported significant digits and by applying conventional rounding methods.

The principle of the present invention is as follows:

In the present invention, through the Michael addition reaction of N-aminoethyl-γ-aminopropyltrimethoxysilane and acrylic esters, an ester group is bonded to the amino group and imine group of N-aminoethyl-γ-aminopropyltrimethoxysilane, and the ester group is hydrolyzed with a trifluoroacetic acid solution to obtain a multidentate functional monomer with a carboxyl group at the end. In the functional monomer, 2 nitrogen atoms and 3 oxygen atoms can coordinate with metal ions. When it is dissolved in methanol and then the template metal ion (copper ion or nickel ion, etc.) aqueous solution is added, the multidentate functional monomercan form a functional monomer-template metal ion complex with it through reversible chelation. Then the cross-linking agent tetraalkoxysilane (for example, tetraethoxysilane, TEOS) is added for bulk polymerization under the catalysis of ammonia water, and after aging, a solid product is obtained. The product is ground and sieved to obtain polymer particles with an appropriate particle size, and then washed with hydrochloric acid to remove template metal ions therein, finally washed to a neutral state, and dried to obtain the ion-imprinted polymer.

The multidentate functional monomer provided the present invention contains five coordination atoms (two nitrogen atoms and three oxygen atoms) and can form a stable complex with the metal ions. Therefore, when the imprinted material is synthesized, the functional monomer is not necessarily excessive, and the molar ratio of the functional monomer to the metal ions is just 1: 1. Because there is no excessive functional monomer in the obtained imprinted material, it is inevitably beneficial to eliminating nonspecific adsorption induced by the functional monomer, which contributes to acquiring high-selectivity ion imprinted material.

In the ionic imprinting technology, the combining stability of the ligand (functional monomer) and the template ions is not only the key to form specific cavities, but also is of great significance on re-identification capability of the imprinted material. Compared with a conventional coordination compound, AAPTS-COOH features better coordination capability, thereby generating a better imprinted effect. The complex formed by the multidentate ligand and the metal ions usually contains more than one annular structure, which is also called a chelate. The five-membered and six-membered rings are relatively stable annular structures. The six-membered ring is more favorable to reduce the ring strain by way of single bond rotation, and thus, the six-membered ring is more stable than the fix-membered ring. The N atoms of AAPTS-COOH are connected to three propionyloxy and can form three six-membered rings and one five-membered ring with the metal ions, with better stability, and a better imprinted effect can be generated.

In the following Examples 1 to 3, N-aminoethyl-γ-aminopropyltrimethoxysilane, aliased as N-(2-aminoethyl)-3-aminopropyltrimethoxysilane (CAS number: 1760-24-3) is used.

### Example 1

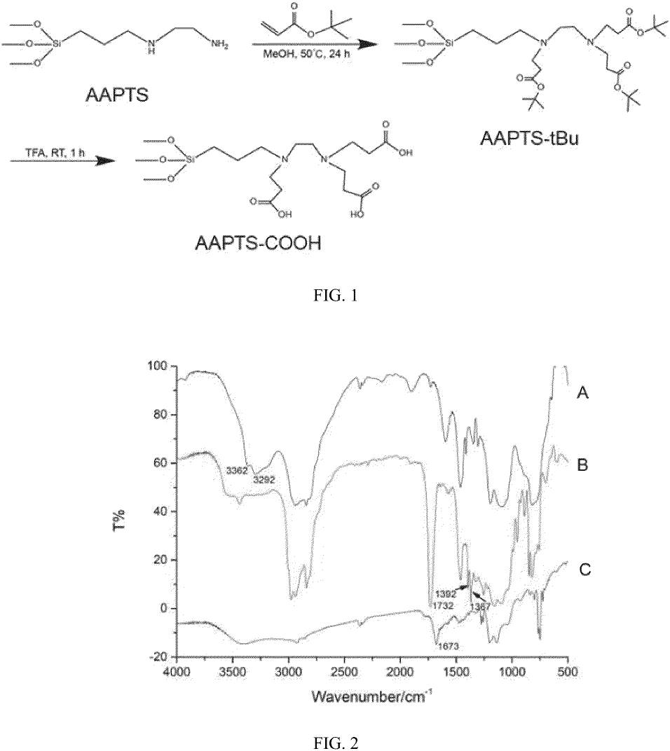

The synthesis route of a N,O-type multidentate functional monomer (AAPTS-COOH) of this example is shown in FIG. 1. The N,O-type multidentate functional monomer is prepared according to the following method. The specific steps are as follows:

(a) Synthesis of AAPTS-tBu:

Add 80 mL of methanol, 8.9 g of N-aminoethyl-γ-aminopropyltrimethoxysilane (AAPTS, 0.04 mol) and 25.6 g of tert-butyl acrylate (0.2 mol) to a three-necked flask equipped with a nitrogen tube and a stirring device sequentially, stir and mix well, introduce N₂into the three-necked flask for 10 minutes to remove oxygen in the reaction system, and then heat the reaction system to 50° C. and react for 24 hours at a constant temperature. Carry out rotary evaporation to remove the excess reactant and solvent to obtain the Michael addition product AAPTS-tBu, and dry the product at 60° C. for 24 h for future use.

(b) Synthesis of AAPTS-COOH: add 5 g of the Michael addition product AAPTS-tBu obtained in the step (a) to 20 mL of trifluoroacetic acid aqueous solution (95%) and hydrolyze at room temperature for 1 hour; after filtration, carry out rotary evaporation at 40° C. under reduced pressure to obtain a viscous liquid; then add 50 mL of cold diethyl ether, filter to obtain the precipitate and then wash it with cold diethyl ether to obtain the N,O-type multidentate functional monomer AAPTS-COOH. Seal and refrigerate the product for future use.

The N,O-type multidentate functional monomer AAPTS-COOH is a siloxane monomer with three carboxylic acid groups and two N atoms, the structural formula being as follows:

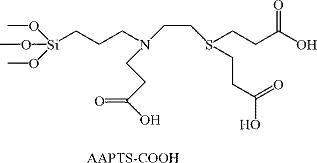

The N,O-type multidentate functional monomer can form six-membered rings and five-membered rings simultaneously with metal ions.

The AAPTS-tBu obtained in the step (a) and the N,O-type multidentate functional monomer AAPTS-COOH obtained in the step (b) of this example are subjected to NMR test respectively. The NMR characterization results are as follows:
AAPTS-tBu :¹HNMR (CD₃OD ; δ/ppm): 3.56 (s, 5H, Si—O—CH₃), 2.73 (t, 6H, N—CH₂—C—C═O), 2.54 (t, 4H, N—CH₂—CH₂—N), 2.44 (t, 2H, N—CH₂—C—C), 2.37 (t, 6H, —CH₂—C═O), 1.57 (m, 2H, C—CH₂—C), 1.45 (s, 27H, —CH₃), 0.61 (t, 2H, Si—CH₂—C).
AAPTS-COOH: ¹HNMR (CD₃OD;δ/ppm): 3.20(t, 6H, N—CH₂—C—C═O), 3.06 (t, 4H, N—CH₂—CH₂—N), 2.86 (t, 2H, N—CH₂—C—C), 2.69 (t, 6H, —CH₂—C═O), 1.89 (m, 2H, C—CH₂—C), 0.75 (t, 2H, Si—CH₂—C).

In addition, the applicant also conducts infrared tests on the raw material N-aminoethyl-γ-aminopropyltrimethoxysilane AAPTS, AAPTS-tBu obtained in the step (a) and N,O-type multidentate functional monomer AAPTS-COOH obtained in the step (b) of this example respectively. The infrared spectra (FT-IR) are shown in FIG. 2. The infrared spectra of AAPTS-tBu (FIG. 2 (B)) show the —N—H absorption peak at 3292 cm⁻¹, tert-butyl absorption peak at 1367 cm⁻¹ and carbonyl absorption peak at 1732 cm⁻¹. The infrared spectra of AAPTS (FIG. 2 (A)) show no characteristic absorption of tert-butyl and carbonyl, therefore, it can be inferred that the Michael addition reaction between AAPTS and tert-butyl acrylate has been completed. The comparison between FIGS. 2 (B) and (C)shows that there is no tert-butyl absorption peak at 1732 cm⁻¹, but there is still a carbonyl absorption peak (1673 cm⁻¹) in the infrared spectrum of AAPTS-COOH, so it can be inferred that the ester group in AAPTS-tBu has been completely hydrolyzed.

Based on the above NMR characterization data and infrared characterization data, it can be concluded that the product prepared in this example is the target product N,O-type multidentate functional monomer AAPTS-COOH.

### Example 2

This example provides a method for preparing a N,O-type multidentate functional monomer(AAPTS-COOH), specifically comprising the following steps:

(a)Add 80 mL of methanol, 8.9 g of N-aminoethyl-γ-aminopropyltrimethoxysilane (AAPTS, 0.04 mol) and 15.5 g of methyl acrylate (0.18 mol) to a three-necked flask equipped with a nitrogen tube and a stirring device sequentially, stir and mix well, introduce N₂into the three-necked flask for 10 minutes to remove oxygen in the reaction system, and then heat the reaction system to 50° C. and react for 24 hours at a constant temperature. Carry out rotary evaporation to remove the excess reactant and solvent to obtain the Michael addition product AAPTS-tBu, and dry the product at 60° C. for 24 h for future use.

(b) Synthesis of AAPTS-COOH: add 4 g of the Michael addition productobtained in the step (a) to 25 mL of trifluoroacetic acid aqueous solution (95%) and hydrolyze at room temperature for 1 hour; after filtration, carry out rotary evaporation at 40° C. under reduced pressure to obtain a viscous liquid; then add 50 mL of cold diethyl ether, filter to obtain the precipitate and then wash it with cold diethyl ether to obtain the N,O-type multidentate functional monomer AAPTS-COOH. Seal and refrigerate the product for future use.

The N,O-type multidentate functional monomer AAPTS-COOH is a siloxane monomer with three carboxylic acid groups and two N atoms, the structural formula being as follows:

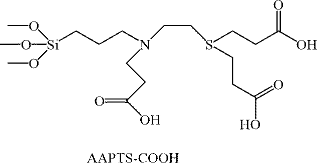

The N,O-type multidentate functional monomer can form six-membered rings and five-membered rings simultaneously with metal ions.

### Example 3

This example provides a method for preparing a N,O-type multidentate functional monomer(AAPTS-COOH), specifically comprising the following steps:

(a)Add 80 mL of methanol, 8.9 g of N-aminoethyl-γ-aminopropyltrimethoxysilane (AAPTS, 0.04 mol) and 20.0 g of ethyl acrylate (0.2 mol) to a three-necked flask equipped with a nitrogen tube and a stirring device sequentially, stir and mix well, introduce N₂ into the three-necked flask for 10 minutes to remove oxygen in the reaction system, and then heat the reaction system to 50° C. and react for 24 hours at a constant temperature. Carry out rotary evaporation to remove the excess reactant and solvent to obtain the Michael addition product, and dry the product at 60° C. for 24 h for future use.

(b) Synthesis of AAPTS-COOH: add 6 g of the Michael addition product obtained in the step (a) to 25 mL of trifluoroacetic acid aqueous solution (95%) and hydrolyze at room temperature for 1 hour; after filtration, carry out rotary evaporation at 40° C. under reduced pressure to obtain a viscous liquid; then add 60 mL of cold diethyl ether, filter to obtain the precipitate and then wash it with cold diethyl ether to obtain the N,O-type multidentate functional monomer AAPTS-COOH. Seal and refrigerate the product for future use.

The N,O-type multidentate functional monomer AAPTS-COOH is a siloxane monomer with three carboxylic acid groups and two N atoms, the structural formula being as follows:

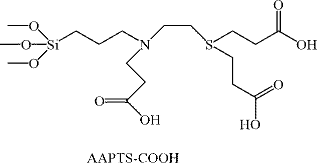

The N,O-type multidentate functional monomer can form six-membered rings and five-membered rings simultaneously with metal ions.

### Application Example 1

This application example provides a method for synthesizing a copper ion-imprinted polymer (Cu²⁺-IIP), comprising the following steps:

Dissolve 2.62 g (0.006 mol) of N,O-type multidentate functional monomer AAPTS-COOH prepared in Example 1 in 6 mL of methanolcompletely, add 12.5 mL of Cu²⁺aqueous solution (32 g/L, pH=5) and stir for 10 minutes.Then add 12.5 g oftetraethoxysilane (TEOS, 0.06 mol) and 1.5 mL of ammonia water solution (NH₃·H₂O, 4.2%), mix well, heat to reflux, and react at constant temperature for 24 hours to obtain a gel-like product. Put the product in an oven at 80° C. for aging for 24 hours, then take out, grind and sieve to obtain particles of 200-300 mesh. Then wash with 1 mol/L hydrochloric acid repeatedly until no Cu²⁺can be detected in the washing solution (detected by flame atomic absorption spectrometry), and then wash with water until neutral, and perform vacuum drying at 60° C. for 24 h to obtain the copper ion-imprinted polymer (Cu²⁺-IIP).

The Cu²⁺-IIP prepared in this application example is characterized by scanning electron microscope and infrared spectrometer, and the results are shown in FIG. 3. The SEM image of FIG. 3(A) shows that the sievedCu²⁺-IIP particles are relatively consistent in size. The infrared spectrum in FIG. 3(B) shows carbonyl absorption at 1654 cm⁻¹, which proves that AAPTS-COOH has been bonded into Cu²⁺-IIP.

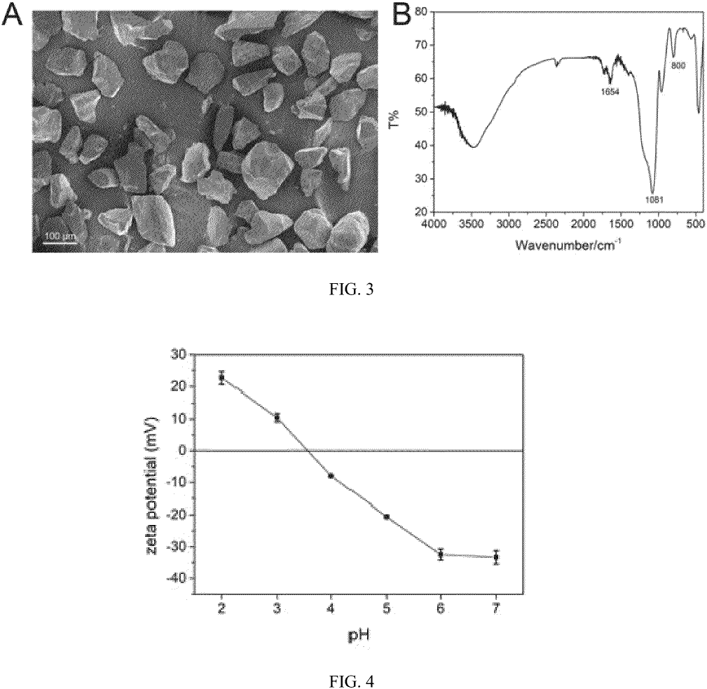

The Zeta potential test results of the ion-imprinted polymer Cu²⁺-IIP prepared in this application example under different pH environments are shown in FIG. 4.

Cu²⁺-IIP in this application example is synthesized by the sol-gel method using AAPTS-COOH as a functional monomer and TEOS as a cross-linking agent. Therefore, Cu²⁺-IIP is actually a type of silica gel particles containing AAPTS-COOH. Its Zeta potential is definitely related to the properties of silicon hydroxyl and AAPTS-COOH. It is believed that, silica gel is generally partially negatively charged except for electrically neutral in a strongly acidic environment. AAPTS-COOH contains three carboxyl groups and 2 amine groups, among which the acidity of the carboxyl group is weak (the pkais about 4.7); therefore, when the pH of the solution rises from 2 to 7, the carboxyl group is definitely changed from a protonated state (electrically neutral) to a deprotonated state (negatively charged); while the amine group is relatively strongly basic, so it always exists in a protonated state (positively charged) in the range of pH=2-7. As shown in FIG. 4, when the pH is 2, the zeta potential of Cu²⁺-IIP is approximately positive, and only AAPTS-COOH is positively charged in Cu²⁺-IIP, so it is not difficult to infer that AAPTS-COOH is definitely contained in Cu²⁺-IIP.

### Application Example 2

The synthesis method of a nickel ion-imprinted polymer (Ni²⁺-IIP) in this application example is basically the same as that of Cu²⁺-IIP, except that the template metal ion solution in Application Example 1 is changed to Ni²⁺ solution (pH=7) from Cu²⁺ solution (pH=5). The steps are as follows:

Dissolve 2.62 g (0.006 mol) of N,O-type multidentate functional monomer AAPTS-COOH prepared in Example 1, 2 or 3 in 6 mL of methanolcompletely, add 12.1 mL of Ni²⁺aqueous solution (29 g/L, pH=7) and stir for 10 minutes.Then add 12.5 g oftetraethoxysilane (TEOS, 0.06 mol) and 1.5 mL of ammonia water solution (NH_{3·}H₂O, 4.2%), mix well, heat to reflux, and react at constant temperature for 24 hours to obtain a gel-like product. Put the product in an oven at 80° C. for aging for 24 hours, then take out, grind and sieve to obtain particles of 200-300 mesh. Then wash with 1 mol/L hydrochloric acid repeatedly until no Ni²⁺can be detected in the washing solution (detected by flame atomic absorption spectrometry), and then wash with water until neutral, and perform vacuum drying at 60° C. for 24 h to obtain the nickelion-imprinted polymer (Ni²⁺-IIP).

### Comparative Application Example 1

In order to measure the selectivity of Cu²⁺-IIP, a non-imprinted polymer called Cu²⁺-NIP is synthesized in this comparative application example. Its synthesis steps are basically the same as those of Cu²⁺-IIP, but no Cu²⁺ is added during the synthesis. The specific steps are as follows:

Dissolve 2.62 g (0.006 mol) of N,O-type multidentate functional monomer AAPTS-COOH prepared in Example 1 to 6 mL of methanol completely, then add 12.5 g of tetraethoxysilane (TEOS, 0.06 mol) and 1.5 mL of ammonia water solution (NH₃·H₂O, 4.2%),mix well, heat to reflux, and react at constant temperature for 24 hours to obtain a gel-like product. Put the product in an oven at 80° C. for aging for 24 hours, then take out, grind and sieve to obtain particles of 200-300 mesh. Then wash with 1 mol/L hydrochloric acid repeatedly for 3 times, and then wash with water until neutral, and perform vacuum drying at 60° C. for 24 h to obtain the non-imprinted polymer (Cu²⁺-NIP).

### Comparative Application Example 2

In order to measure the selectivity ofNi²⁺-IIP, a non-imprinted polymer called Ni²⁺-NIP is synthesized in the present invention. Its synthesis steps are basically the same as those of Ni²⁺-IIP, but no template Ni²⁺solution is added during the synthesis. The specific steps are the same as those for the synthesis of Cu²⁺-NIP.

### Application Example 3

The synthesis method in this application example is basically the same as that of copper ion-imprinted polymer (Cu²⁺-IIP) in the Application Example 1, and the only difference is that the N,O-type multidentate functional monomer AAPTS-COOH in this application example is the N,O-type multidentate functional monomer prepared in Example 2.

### Application Example 4

The synthesis method in this application example is basically the same as that of copper ion-imprinted polymer (Cu²⁺-IIP) in the Application Example 1, and the only difference is that the N,O-type multidentate functional monomer AAPTS-COOH in this application example is the N,O-type multidentate functional monomer prepared in Example 3.

In the present invention, the selectivity of copper ion-imprinted polymer (Cu²⁺-IIP) prepared in the Application Example 1 and non-imprinted material (Cu²⁺-NIP) prepared in Comparative Application Example 1 to Cu²⁺ is tested respectively according to the following method. The specific method is as follows.

Add 0.01 g of Cu²⁺-IIP and Cu²⁺-NIP to 5 mL of a mixed solution of Cu²⁺ and several other metal ions (reference ions) (Cu²⁺/ Zn²⁺, Cu²⁺/ Pb²⁺, Cu²⁺/ Ni²⁺or Cu²⁺/ Co²⁺), respectively; the concentrations of metal ions are all 20 mg/L in the mixed solution, and the pH of the mixed solution is 5. After shaking at 40° C. for 24 h, the concentrations of metal ions in the solution are measured by FAAS respectively, and then the adsorption capacity (Q, mg/g), partition coefficient (K_{D}, L/g), selectivity coefficient (k) and imprinting factor (IF) are calculated. The results are shown in Table 1. The comparison between the selectivity coefficient (k) of Cu²⁺-IIP synthesized by the present invention and those in the literatures is shown in Table 2.

The calculation formulae used in the present invention are as follows:

$$\text{Q =} \frac{\left({C}_{0} - {C}_{6}\right) V}{W} \qquad \text{(1)}$$

$${K}_{D} = \frac{Q}{{C}_{S}} \qquad \text{(2)}$$

$$\text{F =} \frac{{K}_{D \left(\text{template ions}\right)}}{{K}_{D \left(\text{reference ions}\right)}} \qquad \text{(3)}$$

$$\text{IF =} \frac{{Q}_{M I P}}{{Q}_{N I P}} \qquad \text{(4)}$$

In the formula, C₀ (mg/L) and Cₑ (mg/L) represent the initial concentration of ions in the solution and the concentration when reaching the extraction equilibrium, respectively;

V (L) represents the volume of the solution; W (g) represents the mass of the adsorbent; K_{D}(mL/g) represents the partition coefficientof ions in the adsorbent and solution; k_{IIP} and k_{NIP} represent the selectivity coefficients of ion-imprinted polymer (IIP) and non-imprinted polymer (NIP).

TABLE 1

Imprinting factor (IF) and selectivity coefficient (k) of Cu²⁺-IIP of Application Example 1 of the present invention

| Mixture of ions | K_{D}(IIP) | K_{D}(NIP) | IF | k |
|---|---|---|---|---|
| Cu²⁺/Zn²⁺ | 4.1/0.02 | 1.05/0.007 | 1.34 | 192.2 |
| Cu²⁺/Pb²⁺ | 7.78/0.15 | 1.64/0.026 | | 52 |
| Cu²⁺/Ni²⁺ | 2.11/0.058 | 0.79/0.02 | | 36.3 |
| Cu²⁺/Co²⁺ | 5.97/0.038 | 1.25/0.02 | | 155 |

TABLE 2

Selectivity coefficient (k) of Cu²⁺-IIP to Cu²⁺ in the Application Example 1 of the present invention and literatures

| Functional monomer | Sample pH | k | Ref |
|---|---|---|---|
| AAPTS-COOH | 5 | 192 | The present invention |
| Chitosan | 6 | 45 | Literature 1 |
| Glutaraldehyde | 5 | 38 | Literature 2 |
| N-methacryloyl-1-histidine | 5.5 | 2.6 | Literature 3 |
| Polyethyleneimine | 6 | 22 | Literature 4 |

*The reference ion is Zn²⁺
Literature 1: ACS Sustain. Chem. Eng. 2017, 5, 7401-7409;
Literature 2: Anal. Chem. 2014, 86, 7200-7204
Literature 3: RSC Adv. 2015, 5, 97435-97445
Literature 4: Polym. Bull. 2017, 74, 3487-3504.

In order to confirm the universality of the synthesis method of Cu2+-IIP, the present invention synthesized Ni2+-IIP by a similar method (see Application Example 2), and measured its selectivity to Ni2+. The specific measurement method is as follows.

Add 0.01 g of Ni2+-IIP and Ni2+-NIP to 5 mL of Ni2+/Co2+ mixed solution respectively, the concentration of metal ions in the mixed solution is 10 mg/L, and the pH of the mixed solution is 7. After shaking at 40° C. for 24 h, the concentration of metal ions in the solution was measured by FAAS, and then the selectivity coefficient (k) was calculated and compared with the literature value. The results are shown in Table 3.

TABLE 3

Selectivity coefficient (k) of Ni2+-IIP to Ni2+ synthesized by different functional monomers

| Functional monomer | Sample pH | k | Ref |
|---|---|---|---|
| AAPTS-COOH | 7 | 34 | The present invention |
| 2-acrylamido-2-methyl-1-propan esulfonic acid | 7.0 | 33.5 | Literature 5 |
| chitosan and acrylic acid | 6 | 13 | Literature 6 |
| MAA | 7.8 | 3.5 | Literature 7 |
| vinylbenzyl iminodiacetic acid | 7.5 | 10.9 | Literature 8 |

*The reference ion is Co²⁺
Literature 5: Chin. J. Polym. Sci. 2018, 36, 462-471.
Literature 6: Appl. Surf. Sci. 2018, 428, 110-117
Literature 7: Eur. J. Chem. 2018, 9, 57-62.
Literature 8: Eur. Polym. J. 2017, 87, 124-135.

In addition, the selectivity towards Cu²⁺of copper ion-imprinted polymers (Cu²⁺-IIP) obtained in Application Example 3 and Application Example 4 of the present invention also have been measured, and the results demonstrate that the two Cu²⁺-IIPs offer almost the same selective adsorption capability as the copper ion-imprinted polymer obtained in Application Example 1. Thus, the copper ion-imprinted polymer synthesized by AAPTS-COOH as a functional monomer in the present invention has high selective adsorption capacity for copper ions and nickel ions. Furthermore, the Cu²⁺-IIP synthesis method based on AAPTS-COOH of the present invention has good universality, and is expected to be used for the imprinting of other metal ions, simultaneous imprinting of multiple metal ions and the imprinting of organic molecules.

Compared with the prior art, the present invention has the followingbeneficial effects:

The present invention provides an N,O-type multidentate functional monomer (AAPTS-COOH), and the copper ion-imprinted polymer (Cu²⁺-IIP) synthesized by using AAPTS-COOH as a functional monomer has significantly better selectivity to Cu²⁺ than those reported in the existing literatures. Based on the good universality of the Cu²⁺-IIP synthesis method of AAPTS-COOH, when the template metal ionCu²⁺ is replaced by Ni²⁺, the ratio of the functional monomer, the template metal ion and the cross-linking agent used in the synthesis ofCu²⁺-IIP can be directly used in the synthesis of Ni²⁺-IIP. This characteristic is not only beneficial to simplify the synthesis method of ion-imprinted polymer, but also is expected to be used for simultaneous imprinting of multiple metal ions.

1. A method for preparing a N,O-type multidentate functional monomer, comprising the following steps:
(a) adding an organic solvent, N-aminoethyl-γ-aminopropyltrimethoxysilane, and acrylic esters to a flask while stirring, stirring well, introducing N₂into the reaction system for deoxygenation, heating the reactionsystem to 40-60° C. and reacting for 6-28 hours at a constant temperature; after completion of reaction, carrying out rotary evaporation to remove the organic solvent to obtain a Michael addition product; wherein: the molar ratio of the N-aminoethyl-γ-aminopropyltrimethoxysilane to the acrylic esters is 1:3-1:60;
(b) adding a trifluoroacetic acid aqueous solution to the Michael addition product obtained in the step (a), and hydrolyzing at room temperature for 0.5-3 hours; after completion of the hydrolysis reaction, subjecting the hydrolysis product to rotary evaporation, precipitation, filtration, and purification by washing several times to obtain the N,O-type multidentate functional monomer, which is sealed and refrigerated for future use.

2. The method for preparing the N,O-type multidentate functional monomer of claim 1, wherein in the step (a), the acrylic esters can be any one of methyl acrylate, ethyl acrylate, propyl acrylate, butyl acrylate, isobutyl acrylate, tert-butyl acrylate, pentyl acrylate, and hexyl acrylate.

3. The method for preparing the N,O-type multidentate functional monomer of claim 1, wherein the molar ratio of the N-aminoethyl-γ-aminopropyltrimethoxysilane to the acrylic esters in the step (a) is preferably 1:5.

4. A N,O-type multidentate functional monomer prepared according to the method for preparing the N,O-type multidentate functional monomer of claim 1.

5. The method for preparing the N,O-type multidentate functional monomer of claim 1, wherein the N,O-type multidentate functional monomer is a siloxane monomer with three carboxylic acid groups and two N atoms, the structural formula being as follows: 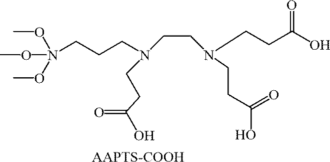
.

6. The method for preparing the N,O-type multidentate functional monomer of claim 5, wherein the N,O-type multidentate functional monomer can form six-membered rings and five-membered rings simultaneously with metal ions.

7. A method for synthesizing an ion-imprinted polymer by using the N,O-type multidentate functional monomer of claim 1, comprising the following steps:
(1) dissolving aN,O-type multidentate functional monomer in an organic solvent to obtain a functional monomer solution; dissolving template metal ions in a buffer solution to obtain a metal ion solution; then mixing the functional monomer solution with the metal ion solution well to obtain a metal ion-functional monomer prepolymerization complex solution; wherein: the molar ratio of the N,O-type multidentate functional monomer to the template metal ions is 1:1;
(2) adding a cross-linking agent tetraalkoxysilane to the prepolymerization complex solution obtained in the step (1), stirring until the solution is clear, then adding ammonia water solution, mixing well and heating to 40-100° C., reacting under a stirring condition for 18-30 hours to obtain a bulk polymerization product, wherein the molar ratio of the cross-linking agent tetraalkoxysilane to the multidentate functional monomer is (3-50):1;
(3) aging the bulk polymerization product obtained in the step (2) at 60-90° C. for 3-48 hours, then taking out, cooling, grinding and sieving, removing the template metal ions with hydrochloric acid, and then washing with water until neutral, finally performing vacuum drying to obtain the ion-imprinted polymer.

8. The method for synthesizing the ion-imprinted polymer of claim 7, wherein in the step (2), the dosage ratio of the ammonia water to the cross-linking agent tetraalkoxysilane is (0.1-20) mL: 0.06 mol.

9. The method for synthesizing the ion-imprinted polymer of claim 7, wherein in the step (1), the metal ion is any one of Cu²⁺ and Ni²⁺.

10. An ion-imprinted polymer obtained by the method for synthesizing the ion-imprinted polymer of claim 7.

11. An application of the ion-imprinted polymer obtained by the synthesizing method of claim 7 in the selective adsorption of metal ions.

12. The method for synthesizing the ion-imprinted polymer of claim 8, wherein the N,O-type multidentate functional monomer is a siloxane monomer with three carboxylic acid groups and two N atoms, the structural formula being as follows: 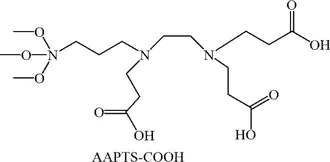
.

13. The method for synthesizing the ion-imprinted polymer of claim 12, wherein the N,O-type multidentate functional monomer can form six-membered rings and five-membered rings simultaneously with metal ions.
